(19) United States
(12) Patent Application Publication
(10) Pub. No.: US 2004/0050965 A1
(43) Pub. Date: Mar. 18, 2004

(54) Atomizer for preventing droplets from splattering

(76) Inventor: Hsiao-Lan Chien, Hsin-Tien City (TW)

Correspondence Address: CHARLES C.H. WU, 7700 IRVINE CENTER DRIVE, SUITE 710, IRVINE, CA, 92618-3043, US

(21) Appl. No.: 10/601,244

(22) Filed: Jun. 20, 2003

(30) Foreign Application Priority Data
Jun. 27, 2002 (TW) 091209786

(51) Int. Cl. B05B 7/32; B05B 1/30; B05B 1/08

(52) U.S. Cl. 239/338; 239/337; 239/589.1; 239/569

(57) ABSTRACT

An atomizer that can prevent the splattering of droplets is revealed. When atomization occurs, the reservoir of an atomizer containing a liquid is closed to prevent droplets from splattering, and when the atomization ceases, the outlet of the reservoir is opened after the droplets gravitate down to the reservoir for mist dissipation. Moreover, a partition may be introduced into the atomizer, and the partition is located between an atomizing source and the outlet of the reservoir for blocking the splattering droplets.

### BACKGROUND OF THE INVENTION

(A) Field of the Invention

The present invention is related to an atomizer, more specifically, to an atomizer capable of droplet splattering prevention.

(B) Description of Related Art

There are several ways of atomization of liquid in modern technology, one of which is to use an oscillator to generate intermittent vibrations. If the frequency of the vibration resonates to that of the molecular bonds of the liquid covering the vibrator, the molecular bonds of the liquid will be broken to form a mist. The process is known as an atomization. Generally, the higher the vibration frequency is, the finer and lighter the mist particles are, and thus better efficiency of mist dissipation can be achieved.

Another way of atomization is to sharply shrink the diameter of a pipe at the outlet, namely a nozzle, to accelerate an airflow carrying liquid to collide with the sidewalls of the nozzle or obstacles placed in front of the outlet, causing the liquid to be broken into smaller droplets.

Because droplets are usually generated in the process of atomization, the present design of atomizers usually uses a large atomization space, a long distance between the atomizing source and the outlet, a fender in front of the outlet, or a zigzag passage to the outlet to prevent the splattering of droplets.

Referring to FIG. 1(a), an atomizer 10 comprises a reservoir 101, a liquid 102, an oscillating device 104 and a power supply 106. The atomization of the liquid 102 is generated at a specific resonating level 108, the dotted line shown in FIG. 1(a), and the height of the resonating level 108 is according to the vibration frequency of the oscillating device 104. For instance, if the vibration frequency is 1.6 MHz, the resonating level 108 is located at approximately four centimeters above the oscillating device 104. If the level 110 of the liquid 102 is above the resonating level 108, mist 112 will burst at the resonating level 108, and thus the liquid at the bursting position will be pushed upwards. Therefore, above the level 110, the mist 112 and the accompanying droplets 114 splatters outwards from the atomization resonance center. The droplets 114 are likely to be formed by the re-combination of the mist 112. In addition, splattering may occur when the droplets 114 drops downwards to the level 110. Referring to FIG. 1(b), if the level 110 is below the resonating level 108, the droplets 114 above the resonating level 108 and the droplets 120 from a liquid pillar 118 caused by the vibration will splatter outwards. Basically, the extent of splattering of the droplets 114, 120 increases with lower liquid level, and the droplets splatter in almost all directions.

Nowadays, the prevention of droplet splattering is still as a bottleneck in the designing of an atomizer. Moreover, the designs to drain out the droplets often make the atomizer difficult to be simplified, restricting the variety of shapes and increasing the time and costs of design and manufacture.

### SUMMARY OF THE INVENTIION

The main objective of the present invention is to prevent droplet splattering of an atomizer, so as to improve the quality of the atomization and enhance the efficiency of mist dissipation. Hence, the atomizer becomes more practical and can be extensively used for other applications.

The structure of the atomizer of the present invention for preventing droplets from splattering can be mainly categorized as follows: (1) the reservoir of the atomizer is able to open and close; and (2) at least one partition is interlaced between the atomizing source and the outlet.

When the atomizing source is activated, the reservoir containing a liquid is closed to prevent the droplets from splattering. In contrast, when the atomization ceases, the outlet of the reservoir is opened after the droplets in the mist gravitate down to the reservoir for dissipating the mist.

The atomizer structure of the present invention comprises a reservoir, an atomizing source and a closable lid, the lid being used as an outlet of the reservoir, the reservoir being used for storing a liquid, and the atomizing source being used for atomizing the liquid. When the atomizing source atomizes the liquid, the outlet, i.e., the lid, is closed to make the reservoir hermetical. When the atomization ceases, the outlet is opened for dissipating the mist out of the reservoir. Furthermore, the actions of the atomizing source and the outlet can be coordinated by a controller to avoid accidental actions.

Furthermore, partitions may be used in the atomizer. The partitions are placed between the atomizing source and the openings to form an interlaced structure, in combination with a housing or by themselves. The partitions of specific sizes and locations have to block all straight lines connecting the atomizing source and the openings of the atomizer, so as to avoid outward splattering droplets that are generated in the process of atomization. As a result, the openings of the reservoir can be placed anywhere on the housing of the reservoir. The openings of such partitions can serve as outlets for mist dissipation, or as the inlet of airflow to blow out the mist.

The atomizer of the present invention using a partitioning device comprises a reservoir, an atomizing source and at least one partition, where the reservoir having at least one opening stores a liquid, and the atomizing source is used for atomizing the liquid. The partition is placed between the atomizing source and the opening to block all straight lines connecting the atomizing source and the opening.

The above-mentioned partitions can be assembled as a structure of a plurality of openings, and can even replace the housing. Therefore, besides for droplet splattering prevention, the partitions allow the mist to be dissipated out.

The atomizer of the present invention can be combined with an airflow generator, a cavity and a pipe to ascertain that the airflow from the airflow generator flows into the reservoir without any backflow.

### BRIEF DESCRIPTION OF THE DRAWINGS

FIGS. 1(a) and 1(b) illustrate a known atomizer;

FIGS. 2(a) and 2(b) illustrate the atomizer of the first embodiment of the present invention;

FIGS. 3(a) and 3(b) illustrate the atomizer of the second embodiment of the present invention;

FIG. 4 illustrates the method of atomization using a partition of the present invention;

FIG. 5 illustrates the partitioning device of the atomizer of the third embodiment of the present invention;

FIG. 6 illustrates the partitioning device of the atomizer of the fourth embodiment of the present invention;

FIG. 7 illustrates the partitioning device of the atomizer of the fifth embodiment of the present invention;

FIGS. 8(a) and 8(b) illustrate the atomizer of the sixth embodiment of the present invention;

FIGS. 9(a) and 9(b) illustrate the atomizer of the seventh embodiment of the present invention;

FIGS. 10(a) and 1 0(b) illustrate the atomizer of the eighth embodiment of the present invention;

FIGS. 11(a) and 11(b) illustrate the atomizer of the ninth embodiment of the present invention;

FIGS. 12(a) and 12(b) illustrate the atomizer of the tenth embodiment of the present invention; and

FIGS. 13(a) and 13(b) illustrate the atomizer of the eleventh embodiment of the present invention.

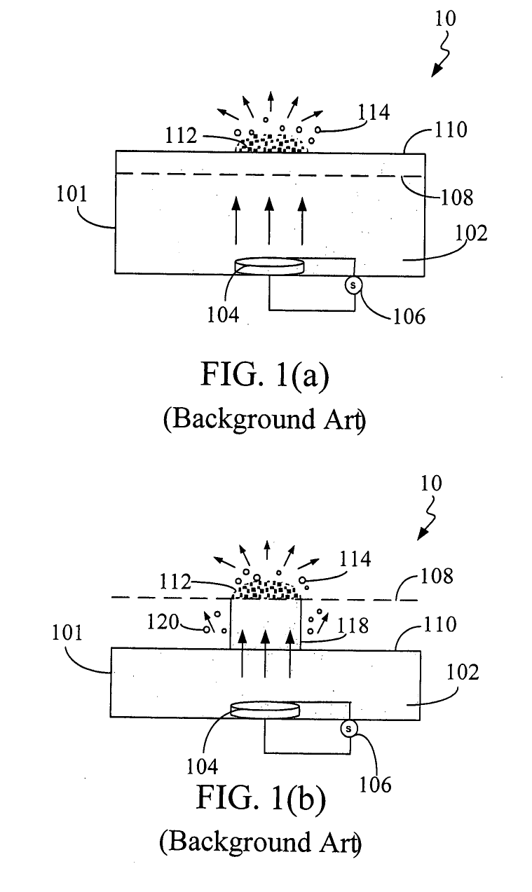

### DETAILED DESCRIPTION OF THE INVENTION

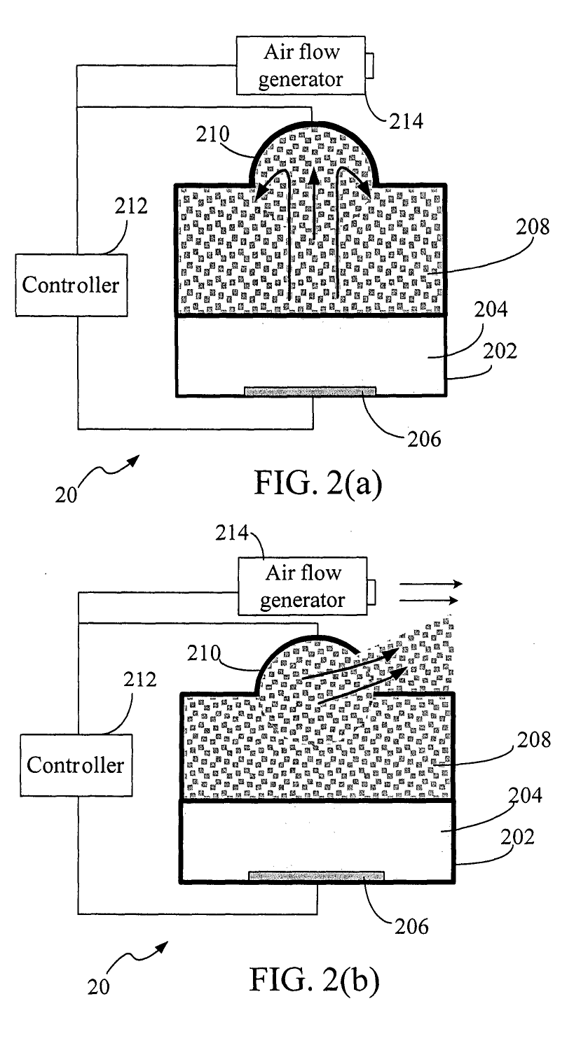

FIG. 2(a) and FIG. 2(b) illustrate the atomizer of the first embodiment of the present invention, of which a reservoir has a closable outlet. Referring to FIG. 2(a), a liquid 204 stored inside the reservoir 202 of the atomizer 20 can be atomized by an atomizing source 206 to form mist 208. The reservoir 202 has a top lid 210 that can be opened and closed as the outlet for the mist 208. The top lid 210 is closed when an atomization occurs, inducing the mist 208 is confined inside the reservoir 202 to prevent the droplets from being splattered outwards.

Referring to FIG. 2(b), when the atomization ceases, the top lid 210 will be opened after the droplets in the mist 208 naturally gravitate down to the reservoir 202 for dissipating the mist 208 without droplets. Moreover, an airflow generator 214 may be added to increase the dissipation efficiency of the mist 208.

The atomizer 20 intermittently releases the mist 208, and a controller 212 can be used to coordinate the actions of the atomizing source 206 and the top lid 210. When the atomizing source 206 is activated, the top lid 210 has to be closed. In contrast, when the atomizing source 206 ceases, the top lid 210 will be opened after the droplets fall down to the reservoir 202 for dissipating the mist 208. In addition, the airflow generator 214 can also be controlled by the controller 212 to coordinate the open or close actions of the top lid 210.

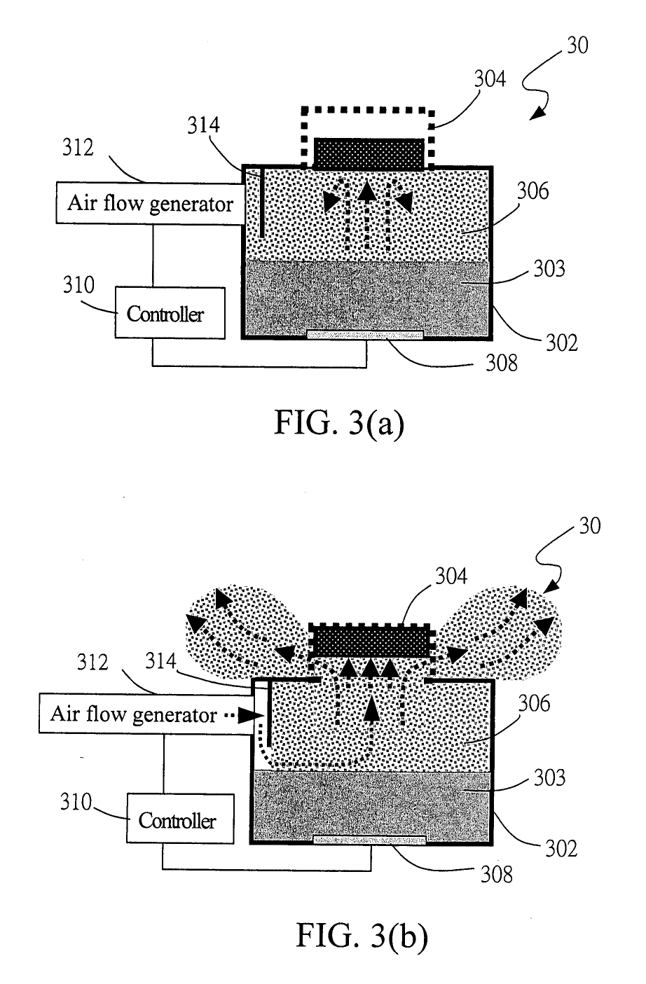

FIG. 3(a) and FIG. 3(b) illustrate the atomizer of the second embodiment of the present invention, of which a reservoir has a closable outlet as well. Referring to FIG. 3(a), a liquid 303 stored inside the reservoir 302 of an atomizer 30 can be atomized by an atomizing source 308 controlled by a controller 310 to form mist 306. The reservoir 302 has a light-weight lid 304 as the outlet of the mist 306. When atomization occurs, the lid 304 is closed to confine the mist 306 inside the reservoir 302 to prevent the droplets from being splattered outwards. The controller 310 is further connected to an airflow generator 312, and a fender 314 is placed in the front of the outlet of the airflow generator 312.

Referring to FIG. 3(b), when the atomization ceases, the airflow generator 312 will feed air into the reservoir 302 after the droplets in the mist 306 naturally gravitate down to the reservoir 302. As a result, the internal pressure of the reservoir 302 is higher than the outside pressure, and the lid 304 will be pushed upwards to dissipate the mist 306 outwards without droplets.

The atomizer 30 intermittently releases the mist 306, and the controller 310 can coordinate the actions between the atomizing source 308 and the airflow generator 312. When the atomizing source 308 is activated, the lid 304 is closed. In contrast, when the atomizing source 308 is off, the airflow generator 312 will feed air into reservoir 302 after the droplets fall down to the reservoir 302 to dissipate the mist 306 outwards along with the airflow. Afterwards, if the atomizing source 308 is reactivated, the airflow generator 312 will stop, and thus the lid 304 will resumes the closed position.

Because the fender 314 is fairly close to the wall of the reservoir 302 at the outlet of the airflow generator 312, the backflow of condensed mist into the outlet can be avoided, and thus the airflow can be sent out smoothly. The lid 304 can be a light-weight and flexible thin plate. When the airflow generator 312 is off, the lid 304 will be closed due to gravitation to avoid the backflow of droplets and the mist 306 entering the reservoir 302 and the airflow generator 312.

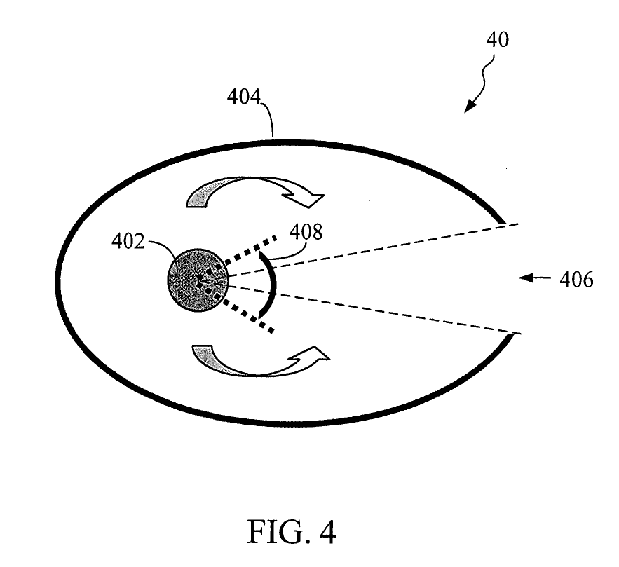

For providing the openings of various types, shapes, and sizes, a fixed or an unfixed partition structure may be placed between the straight lines connecting an atomizing source and an opening of a housing to prevent droplet splattering. Nevertheless, the mist still can be smoothly dissipated due to the different motions of the droplets and the mist. Referring to FIG. 4, the atomizing source 402 of an atomizer 40 is contained within a housing 404 of a opening 406, in which the angle between the lines connecting the two edges of the housing 404 and the center of the atomizing source 402 is referred to as the divergent angle, and the angle between the lines connecting the edges of a partition 408 and the center of the atomizing source 402 is referred to as the shielding angle. The shielding angle must be larger than or equal to the divergent angle, i.e., the two edges of the housing 404 and the edges of the partition 408 are interlaced or overlapped, so the linear divergence from the atomizing source 402 in all directions are blocked either by the housing 404 or by the partition 408. Owing to no direct passage between the atomizing source 402 and the opening 406, the droplets splattered from the atomizing source 402 towards the opening 406 will be blocked. Nevertheless, because a particle of mist is much lighter than a droplet, the mist still can be dissipated out through the two sides of the partition 408 and the opening 406 instead of being blocked by the partition 408, which is indicated by the arrow sign. If the partition 408 is closer to the atomizing source 402, i.e., a larger shielding angle, the partition 408 can be smaller. Besides, for easier mist dissipation, the partition 408 can be taken apart into several small partitions, each partition is interlaced with the neighboring one but kept apart at an interval for the passage of the mist. The dimension of the interval also has to comply with the rule that the shielding angle must be larger than or equal to the divergent angle. In other words, the lines connecting any point within the atomizing source 402 and the edges of the partition 408 should not run directly towards the outside. Besides being applied in a common symmetric structure, the above-mentioned atomizer can also be applied in an asymmetric one. The above simple atomizer not only avoids droplet splattering, but also allows the air to flow out smoothly.

The following embodiments are in accordance with the partitioning structure mentioned above, in order to prevent droplet splattering.

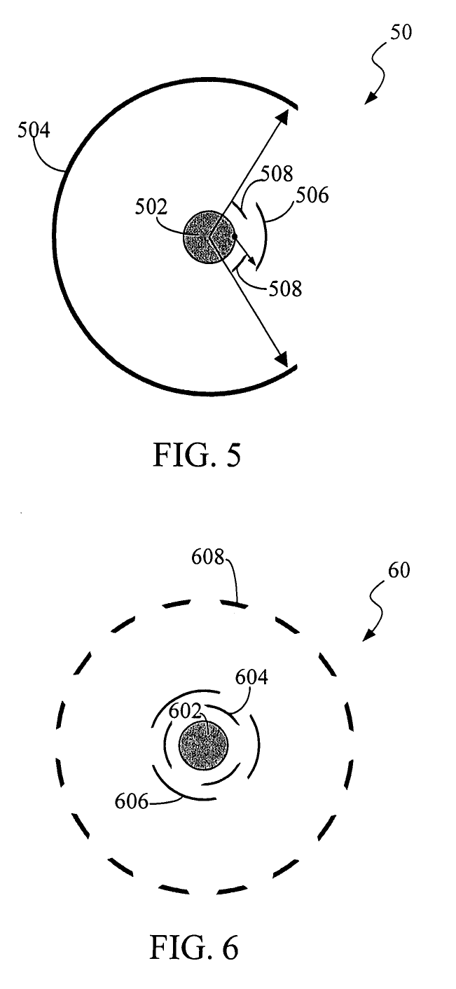

FIG. 5 illustrates the partitioning structure of the atomizer of the third embodiment of the present invention. An partitioning structure 50 comprises an atomizing source 502, a housing 504, an outer partition 506 and two inner partitions 508, where the outer partition 506 is interlaced with the inner partitions 508 to form a splatter prevention structure. The positions of the outer partition 506 and inner partitions 508 have to block the linear splattering from any point within the atomizing source 502 to the opening of the housing 504. Therefore, the point at the very far right of the atomizing source 502 has to be taken into consideration to avoid any omission. Similarly, the outer partition 506 and inner partitions 508 are kept away from each other at an interval to allow the mist to pass, and the interval has to be in light of the rule that the shielding angle must be larger than or equal to the divergent angle as well.

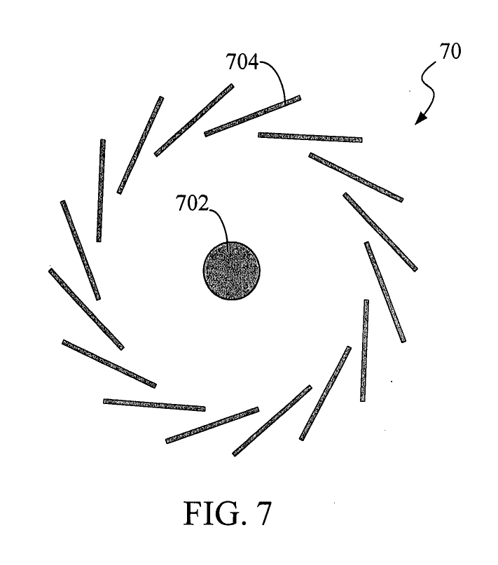

FIG. 6 illustrates the partitioning structure of the atomizer of the fourth embodiment of the present invention. A partitioning structure 60 comprises an atomizing source 602, three inner partitions 604, three outer partitions 606 and a housing 608 of sixteen openings. The inner partitions 604 and the outer partitions 606 should be interlaced, and the inner partition 604 and outer partitions 606 have to be away from each other at an interval to allow the mist to pass, and the dimension of the interval is in light of the rule that the shielding angle must be larger than or equal to the divergent angle to prevent droplets splattering.

For application in an atomizer with a large opening or multiple openings, the partitions can be arranged as the partitions 508, 506, or 604, 606 of the third or the fourth embodiment. The interlaced portion of the partitions should be larger than or equal to zero, i.e., the straight lines connecting any point within the atomizing source and the edges of the inner and outer partitions should not run directly towards the outside. Besides, the intervals between any two interlaced partitions cannot be too narrow, otherwise the mist dissipation will be hindered.

FIG. 7 illustrates the atomizer structure of the fifth embodiment of the present invention. The atomizing source 702 of the partitioning structure 70 is enclosed by sixteen partitions 704, and each partition 704 is interlaced and shielded by the neighboring one. The partitions 704 can completely block the splattering lines from the atomizing source 702, and the openings between partitions are formed. Therefore, the partitions 704 can be a substitute of a housing.

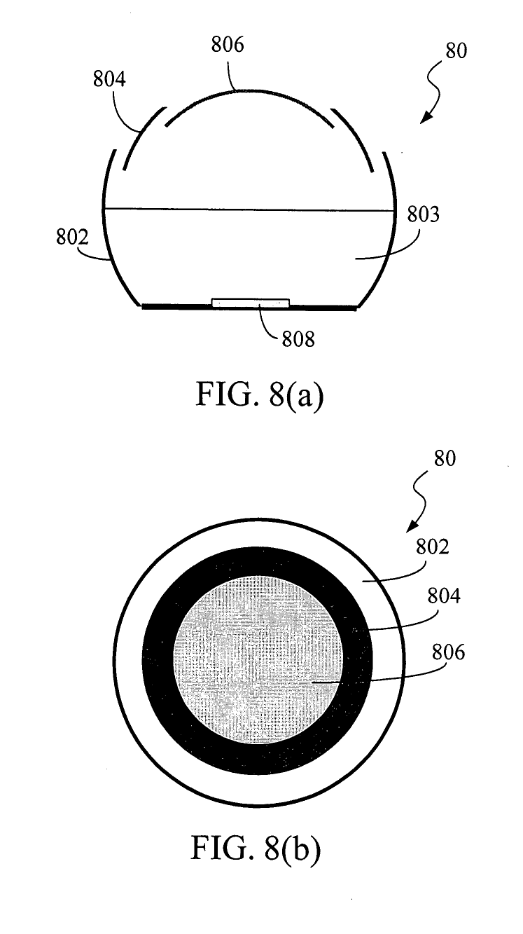

FIG. 8(a) and FIG. 8(b) illustrate the atomizer of the sixth embodiment of the present invention, which shows an application of interlaced partitions in an atomizer. Referring to FIG. 8(a), an atomizer 80 comprises a reservoir 802, a liquid 803, a ring-shaped partition 804, a top lid 806 and an atomizing source 808, where the ring-shaped partition 804, the reservoir 802 and the top lid 806 are mutually interlaced and kept away from the neighboring one at an interval to allow the mist to pass. The straight lines connecting any point within the atomizing source 808 and the edges of the reservoir 802, the ring-shaped partition 804 and the top lid 806 cannot run directly towards the outside, so as to prevent the droplet splattering. FIG. 8(b) shows the top view of the atomizer 80.

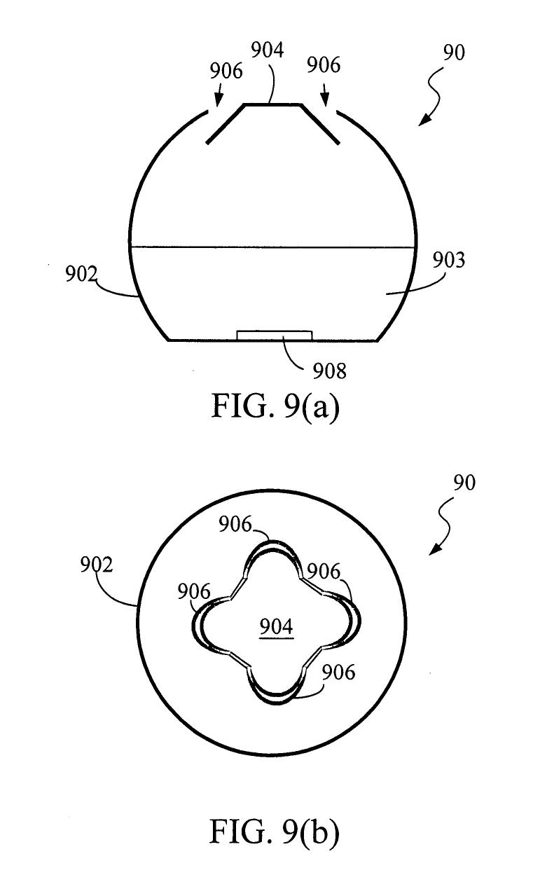

FIG. 9(a) and FIG. 9(b) illustrate the atomizer of the seventh embodiment of the present invention, which shows another application of interlaced partitions in an atomizer structure. Referring to FIG. 9(a), an atomizer 90 comprises a reservoir 902, a top lid 904, a liquid 903 and an atomizing source 908, where the top lid 904 has four sunken openings 906, and the bevels of the top lid 904 is interlaced with the reservoir 902. The interlaced area may be larger than or equal to zero. The straight lines connecting any point in the atomizing source 908 and the edges of the top lid 904 should not run directly towards the outside. Besides, the intervals of the top lid 904 and the reservoir 902 of the interlaced area cannot be too narrow, otherwise the mist dissipation will be hindered. FIG. 9(b) shows the top view of the atomizer 90.

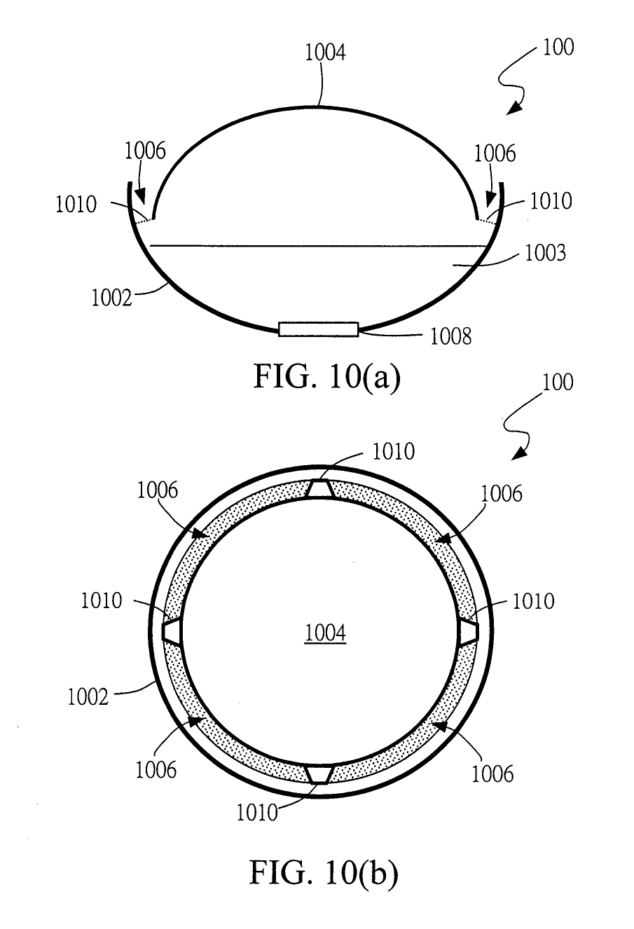

FIG. 10(a) and FIG. 10(b) illustrate the atomizer of the eighth embodiment of the present invention, which shows a further application of interlaced partitions in an atomizer. Referring to FIG. 10(a), an atomization apparatus 100 comprises a reservoir 1002, a top lid 1004, a liquid 1003 and an atomizing source 1008, where the top lid 1004 is interlaced with the two edges of the reservoir 1002, and the interval of the reservoir 1002, also used as the opening, is constituted by four supports 1010. The straight lines connecting any point in the atomizing source 1008 and the edges of the top lid 1004 or the edges of the reservoir 1002 should not directly run towards the outside. Besides, the intervals cannot be too narrow, otherwise the mist dissipation will be hindered. FIG. 10(b) shows the top view of the atomizer 100.

The interlaced partitions of the present invention can block the splattering of the droplets, and still allow mist to be easily dissipated. However, because the mist is an accumulation of molecules whose weight is heavier than the molecules of air, the mist is apt to be precipitated and condensed. If airflow is introduced around the atomizer to increase the efficiency of the mist dissipation, mist precipitation and condensation can be avoided.

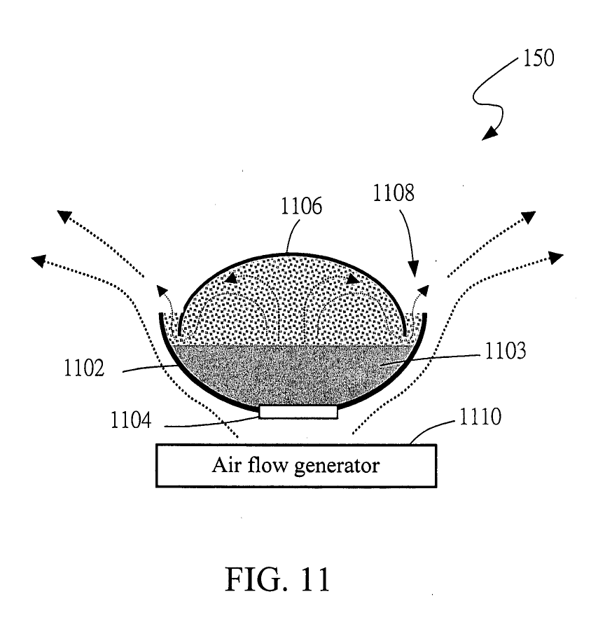

The atomizer of the ninth embodiment of the present invention is shown in FIG. 11. In comparison with the atomizer 100 of the eighth embodiment, an atomizer 150 further comprises an airflow generator 1110, of which a reservoir 1102 and a top lid 1106 forms an interlaced structure. The straight lines connecting any point in the atomizing source 1104 and the edges of the top lid 1106 or the edges of the reservoir 1102 cannot run directly towards the outside, so as to block the droplets but still allow the mist generated from the liquid 1103 to be smoothly dissipated through openings 1108. The airflow generated by the airflow generator 1110 can carry the mist to speed up mist dissipation, reducing the chance of mist precipitation or condensation.

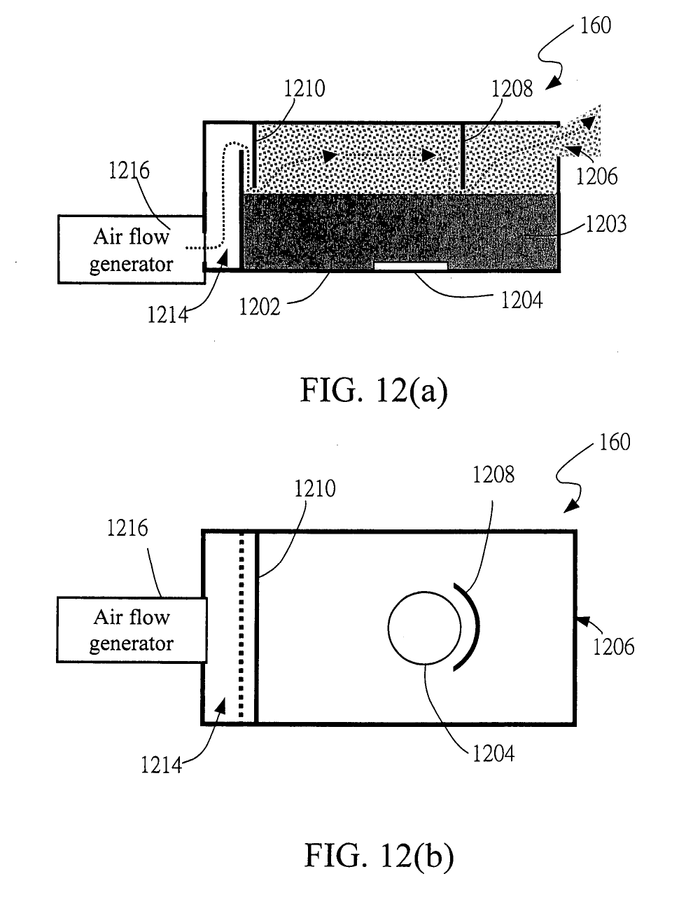

FIG. 12(a) and FIG. 12(b) illustrate the atomizer, using a cavity to guide auxiliary airflow, of the tenth embodiment of the present invention. Referring to FIG. 12(a), an atomizer 160 comprises a reservoir 1202, an atomizing source 1204, a partition 1208, a fender 1210 and an airflow generator 1216, where the fender 1210 divides the reservoir to form a cavity 1214 as the channel for airflow. The reservoir 1202 storing a liquid 1203 has an opening 1206 for mist dissipation. When an atomization occurs, the airflow generated by the airflow generator 1216 flows through the cavity 1214 and the fender 1210 into the reservoir 1202 to carry the mist out of the reservoir 1202 through the opening 1206. The straight lines connecting the outlet of the cavity 1214 and the atomizing source 1204 are blocked by the fender 1210. FIG. 12(b) is the top view of the atomization apparatus 160.

The fender 1210 located at the inlet of the airflow may be fixed, which is pretty close to the sidewall of the cavity 1214, i.e., the fender 1210 is closed to the airflow inlet. As a result, if the mist is going to flow back to the cavity 1214, the mist will be condensed to make the airflow stay running smoothly. In addition, the opening 1206 can be covered by a light-weight and top-fixed flexible thin plate. When the airflow generator 1216 is off, the thin plate is closed. In contrast, when airflow is added, the thin plate is blown open. This embodiment can prevent the droplets and mist from back-flowing into the reservoir 1202 and airflow generator 1216.

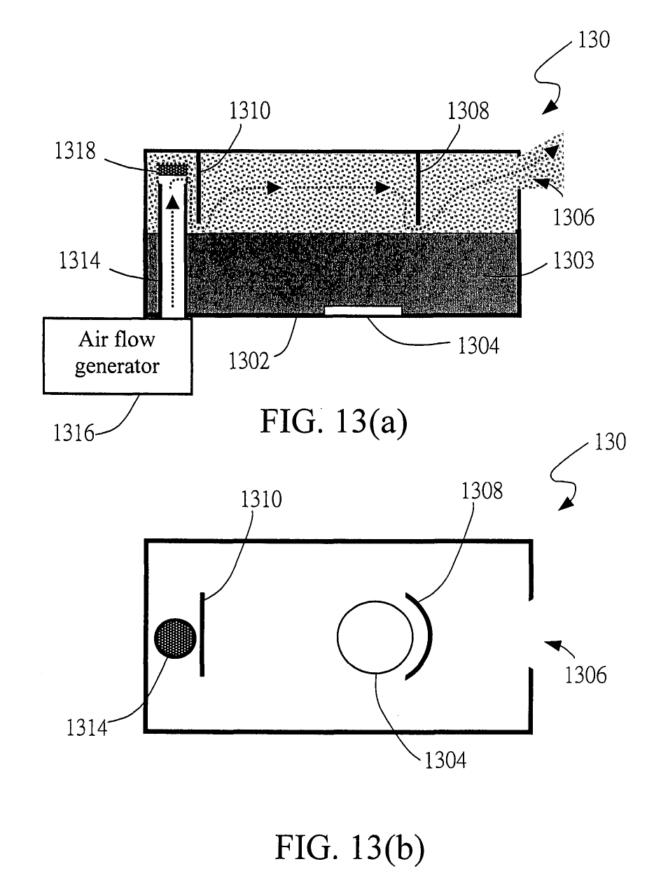

FIG. 13(a) and 13(b) illustrate the atomizer, using a pipe including a valve to guide auxiliary airflow, of the eleventh embodiment of the present invention. Referring to FIG. 13(a), an atomizer 130 comprises a reservoir 1302, an atomizing source 1304, a partition 1308, a fender 1310 and an airflow generator 1316. In comparison with the tenth embodiment, the cavity 1214 is replaced with a pipe 1314 as the channel for airflow, and a valve 1318 on the top of the pipe 1314 is used to control the air input. The reservoir 1302 of an opening 1306 stores a liquid 1303. When atomization occurs, the air flows through the pipe 1314, the fender 1310 into the reservoir 1302 to carry the mist out of the reservoir 1302, and the droplets can be blocked by the partition 1308.

The fender 1310 near the air inlet can block the droplets that splatter towards the valve 1318. The valve 1318 may be a light-weight and flexible thin plate fixed at one end. Moreover, the opening 1306 can be covered by a light-weight and top-fixed flexible thin plate as well. When the airflow generator 1316 is off, the thin plate is closed. In contrast, when airflow is started, the thin plate is blown open.

The above-described embodiments of the present invention are intended to be illustratively only. Numerous alternative embodiments may be devised by those skilled in the art without departing from the scope of the following claims.

What is claimed is:

1. An atomizer for preventing droplets from splattering, comprising:
a reservoir for storing a liquid;
an atomizing source for atomizing the liquid so as to generate a mist; and
an outlet, which is closed to make the reservoir hermetical when the atomizing source atomizes the liquid and is open to dissipate the mist out of the reservoir when the atomizing source is not activated.

2. The atomizer in accordance with claim 1, wherein the outlet is open after the droplets generated during atomization gravitates down to the reservoir.

3. The atomizer in accordance with claim 1, further comprising an airflow generator for increasing the efficiency of mist dissipation and preventing mists from precipitating.

4. The atomizer in accordance with claim 1, wherein the reservoir comprises a cavity separated by a partition, and straight lines connecting an outlet of the cavity and the atomizing source are blocked by the partition.

5. The atomizer in accordance with claim 1, further comprising a controller to coordinate the atomizing source and the outlet.

6. The atomizer in accordance with claim 3, wherein the outlet is controlled by the pressure of the airflow generated from the airflow generator.

7. The atomizer in accordance with claim 1, wherein the atomizing source is an oscillator.

8. The atomizer in accordance with claim 4, wherein the outlet of the cavity has a valve.

9. An atomizer for preventing droplets from splattering, comprising:
a reservoir for storing a liquid, the reservoir includes at least one opening;
an atomizing source for atomizing the liquid; and
at least one partition located between the atomizing source and the at least one opening interlacing with the edges of the reservoir, and all straight lines connecting the atomizing source and the at least one opening being blocked by the at least one partition.

10. The atomizer in accordance with claim 9, wherein the partitions are mutually interlaced between the opening and the atomizing source.

11. The atomizer in accordance with claim 9, wherein the partitions are mutually interlaced and arranged as circles.

12. The atomizer in accordance with claim 9, wherein the at least one partition is shaped as a ring.

13. The atomizer in accordance with claim 9, wherein the at least one partition is a top lid which is interlaced with the reservoir.

14. The atomizer in accordance with claim 9, wherein the opening is used as an inlet of airflow.

15. The atomizer in accordance with claim 9, further comprising an airflow generator for providing airflow so as to increase the efficiency of mist dissipation and to prevent mist from precipitating.

16. The atomizer in accordance with claim 9, wherein the reservoir further comprises a cavity separated by a fender, and straight lines connecting an outlet of the cavity and the atomizing source are blocked by the fender.

17. The atomizer in accordance with claim 16, wherein the cavity has a valve.

18. An atomizer for preventing droplets from splattering, comprising:
a reservoir for storing a liquid;
an atomizing source for atomizing the liquid; and
a plurality of partitions forming a plurality of openings of the reservoir, and all straight lines connecting the atomizing source and the plurality of openings being blocked by the plurality of partitions.

19. The atomizer in accordance with claim 18, wherein the openings are used as airflow inlets

20. The atomizer in accordance with claim 18, further comprising an airflow generator for providing airflow so as to increase the efficiency of mist dissipation and to prevent mist from precipitating.
